(19) United States
(12) Patent Application Publication
(10) Pub. No.: US 2024/0330960 A1
(43) Pub. Date: Oct. 3, 2024

(54) DETECTING FRAUDULENT E-COMMERCE WEBSITES

(71) Applicant: Palo Alto Networks, Inc., Santa Clara, CA (US)

(72) Inventors: Marzieh Bitaab, Chandler, AZ (US); Seokkyung Chung, Sunnyvale, CA (US); Wei Wang, Milpitas, CA (US); Lucas Hu, Palo Alto, CA (US)

(21) Appl. No.: 18/227,817

(22) Filed: Jul. 28, 2023

Related U.S. Application Data
(60) Provisional application No. 63/455,233, filed on Mar. 28, 2023.

(51) Int. Cl. G06Q 30/018

(52) U.S. Cl. CPC G06Q 30/0185

(57) ABSTRACT

Techniques for identifying fraudulent e-commerce websites (FCWs) are disclosed. A candidate URL is received. A model, previously trained (e.g., using a first set of tokens extracted from a set of benign shopping sites and a second set of tokens extracted a set of previously identified FCWs) is used to evaluate content associated with the URL. A remedial action is performed in response to the determination.

### REFERENCE TO OTHER APPLICATIONS

This application claims priority to U.S. Provisional Patent Application No. 63/455,233 entitled FAKE SHOP DETECTION filed Mar. 28, 2023 which is incorporated herein by reference for all purposes.

### BACKGROUND OF THE INVENTION

Internet users are under constant attack from cybercriminals that want to defraud them of their hard-earned money. One type of attack is a phishing attack, where the ultimate goal of the attacker is to steal information from the user, such as a social security account number or banking credentials. Phishing attacks are generally a well-known and well-studied phenomenon. Unfortunately, new types of defrauding attacks are emerging, which are less understood and for which existing (e.g., phishing) protections are insufficient. Therefore, an ongoing need exists to detect and mitigate such defrauding attacks.

### BRIEF DESCRIPTION OF THE DRAWINGS

Various embodiments of the invention are disclosed in the following detailed description and the accompanying drawings.

FIG. 1 illustrates an example of an environment in which various types of attacks can be detected and mitigated.

FIG. 2A illustrates an embodiment of a data appliance.

FIG. 2B is a functional diagram of logical components of an embodiment of a data appliance.

FIG. 2C illustrates an example of a DNS module incorporated into an embodiment of a security platform.

FIG. 3 illustrates an example of logical components that can be included in a system for analyzing samples.

FIG. 4A illustrates a cryptocurrency website.

FIG. 4B illustrates a fake cryptocurrency website.

FIG. 5 illustrates an approach to building a dataset of fraudulent commercial websites.

FIG. 6 illustrates an overview of an embodiment of a system for classifying fraudulent e-commerce websites.

FIG. 7 illustrates an embodiment of a process for detecting FCW scams.

FIG. 8 illustrates an example of a model that can be used to detect FCW scams.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. Overview

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content-not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes, dynamically feeding that context into security policies, thereby eliminating the policy lag that may occur when VMs change.

### II. Example Environment

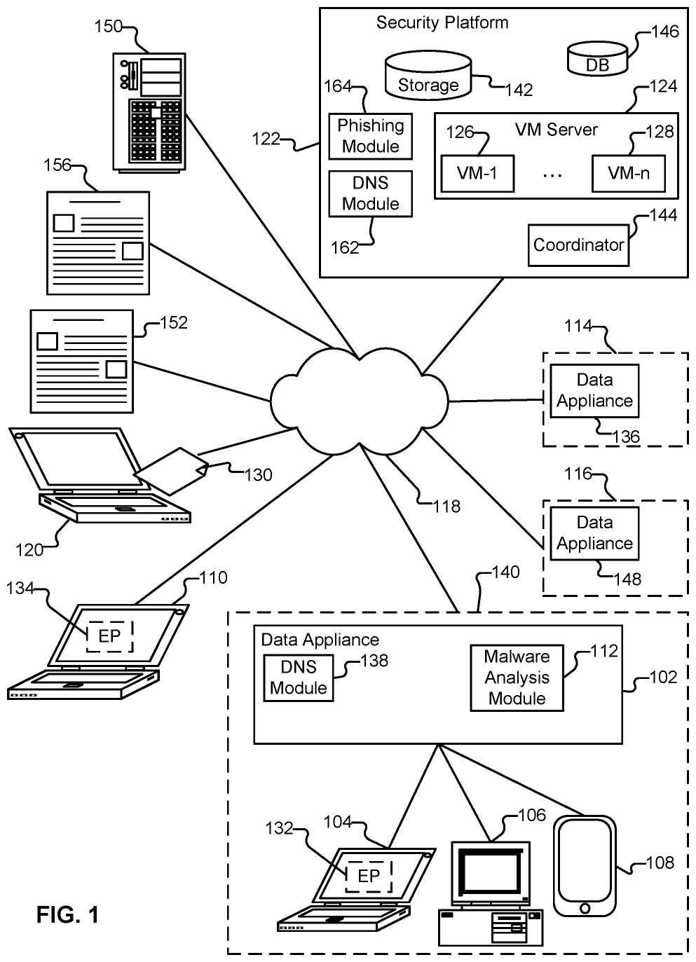

FIG. 1 illustrates an example of an environment in which various types of attacks can be detected and mitigated. As will be described in more detail below, information (e.g., as determined by security platform 122) can be variously shared and/or refined among various entities included in the environment shown in FIG. 1. And, using techniques described herein, devices, such as endpoint client devices 104-110 can be protected from various harms.

The term “application” is used throughout the Specification to collectively refer to programs, bundles of programs, manifests, packages, etc., irrespective of form/platform. An “application” (also referred to herein as a “sample”) can be a standalone file (e.g., a calculator application having the filename “calculator.apk” or “calculator.exe”) and can also be an independent component of another application (e.g., a mobile advertisement SDK or library embedded within the calculator app).

“Malware” as used herein refers to an application that engages in behaviors, whether clandestinely or not (and whether illegal or not), of which a user does not approve/would not approve if fully informed. Examples of malware include Trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package.apk (APK) file that appears to an end user to be a free game, but stealthily sends SMS premium messages (e.g., costing $10 each), running up the end user's phone bill. Another example of malware is an Apple IOS flashlight application that stealthily collects the user's contacts and sends those contacts to a spammer. Other forms of malware can also be detected/thwarted using the techniques described herein (e.g., ransomware). And, while various information is described herein as being generated for malicious applications, techniques described herein can also be used in various embodiments to generate profiles for other kinds of applications (e.g., adware profiles, goodware profiles, etc.). Further, various techniques described herein can be used to protect endpoints (and/or users of such endpoints) against other types of malicious activities, such as detecting and mitigating phishing or other fraudulent websites that may not make use of malware per se.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, etc.). In the example environment shown in FIG. 1, client devices 104-108 are a laptop computer, a desktop computer, and a tablet (respectively) present in an enterprise network 140. Client device 110 is a laptop computer present outside of enterprise network 140 (belonging to the “ACME Company”).

Data appliance 102 is configured to enforce policies regarding communications between clients, such as client devices 104 and 106, and nodes outside of enterprise network 140 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers. In some embodiments, data appliance 102 is also configured to enforce policies with respect to traffic that stays within enterprise network 140.

Although illustrated as a single element in FIG. 1, enterprise network 140 can comprise multiple networks, any/each of which can include one or multiple data appliances or other components that embody techniques described herein. For example, the techniques described herein can be deployed by large, multi-national companies (or other entities) with multiple offices in multiple geographical locations. And, while client devices 104-108 are illustrated in FIG. 1 as connecting directly to data appliance 102, it is to be understood that one or more intermediate nodes (e.g., routers, switches, and/or proxies) can be and typically are interposed between various elements in enterprise network 140.

In various embodiments, data appliance 102 includes a DNS module 138, which is configured to receive (e.g., from security platform 122) a list of domains (e.g., a list of attack domains) for which queries (e.g., made by client device 104), if observed (e.g., within network 140), are problematic. DNS module 148 can also be configured to send (e.g., to security platform 122) DNS query data (e.g., logs of DNS requests made by clients such as client devices 104-108). DNS module 138 can be integrated into appliance 102 (as shown in FIG. 1) and can also operate as a standalone appliance in various embodiments. And, as with other components described throughout the Specification, DNS module 138 can be provided by the same entity that provides appliance 102 (and/or security platform 122), and can also be provided by a third party (e.g., one that is different from the provider of appliance 102 or security platform 122). Further, as with other elements of appliance 102, in various embodiments, the functionality provided by DNS module 138 (or portions thereof) is instead/in addition provided by software executing on a client (e.g., client 104).

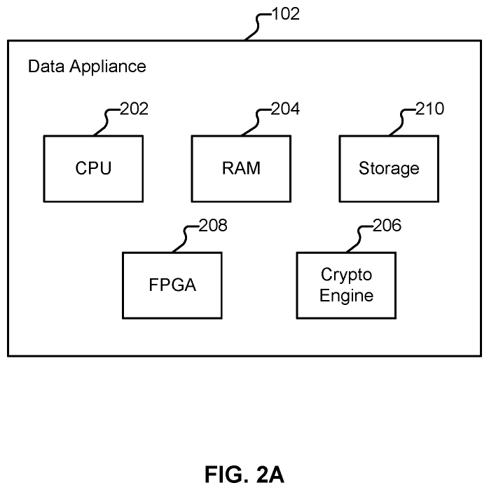

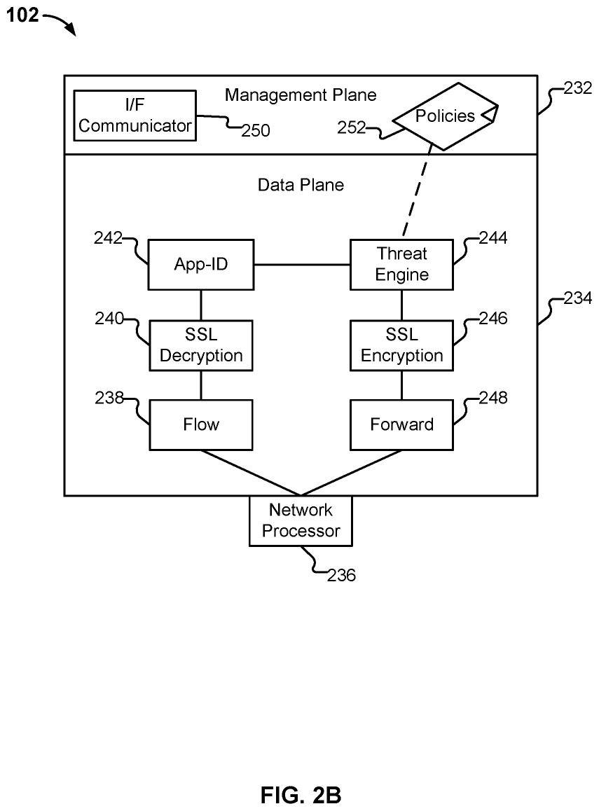

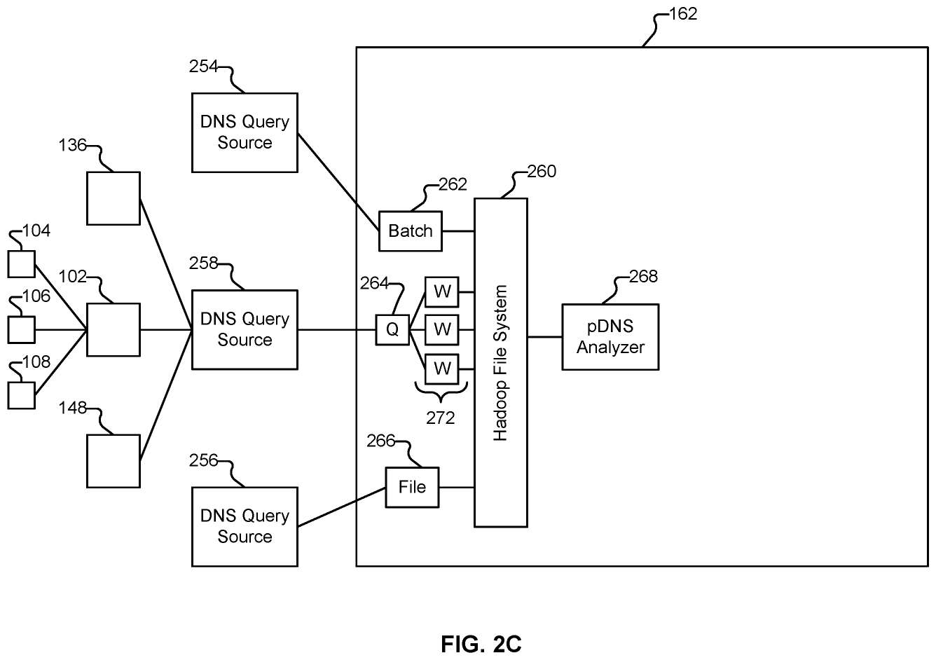

An embodiment of a data appliance is shown in FIG. 2A. The example shown is a representation of physical components that are included in data appliance 102, in various embodiments. Specifically, data appliance 102 includes a high performance multi-core Central Processing Unit (CPU) 202 and Random Access Memory (RAM) 204. Data appliance 102 also includes a storage 210 (such as one or more hard disks or solid state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures, hostname/URL categorization information, malware profiles, and machine learning models. Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general purpose computer, a computer server, a gateway, and/or a network/routing device. In some embodiments, at least some services described as being provided by data appliance 102 are instead (or in addition) provided to a client device (e.g., client device 104 or client device 110) by software executing on the client device (e.g., endpoint protection application 132).

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Java, python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, e.g., a web browsing session, the identified application can change, and such changes will be noted by data appliance 102. For example, a user may initially browse to a corporate Wiki (classified based on the URL visited as “Web Browsing—Productivity”) and then subsequently browse to a social networking site (classified based on the URL visited as “Web Browsing—Social Networking”). Different types of protocols have corresponding decoders.

Based on the determination made by application identification engine 242, the packets are sent to an appropriate decoder. Threat engine 244 is configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for subscriber/IP flows based on various extracted parameters/information from monitored session traffic flows. An interface (I/F) communicator 250 is provided for management communications (e.g., via (REST) APIs, messages, or network protocol communications or other communication mechanisms).

### III. Security Platform

Returning to FIG. 1, in various embodiments, security platform 122 is configured to provide a variety of services (including to data appliance 102), including analyzing samples (e.g., of documents, applications, etc.) for maliciousness, categorizing applications, categorizing domains/URLs/URIs, etc.

Suppose a malicious individual (using system 120) has created malware 130. The malicious individual hopes that a client device, such as client device 104, will execute a copy of malware 130, compromising the client device, and causing the client device to become a bot in a botnet. The compromised client device can then be instructed to perform tasks (e.g., cryptocurrency mining, or participating in denial of service attacks) and to report information to an external entity, such as command and control (C&C) server 150, as well as to receive instructions from C&C server 150, as applicable.

Suppose data appliance 102 has intercepted an email sent (e.g., by system 120) to a user, “Alice,” who operates client device 104 as an employee of ACME Corporation (who maintains enterprise network 140). A copy of malware 130 has been attached by system 120 to the message. As an alternate, but similar scenario, data appliance 102 could intercept an attempted download by client device 104 of malware 130 (e.g., from a website). In either scenario, data appliance 102 determines whether a signature for the file (e.g., the email attachment or website download of malware 130) is present on data appliance 102. A signature, if present, can indicate that a file is known to be safe (e.g., is whitelisted), and can also indicate that the file is known to be malicious (e.g., is blacklisted).

In various embodiments, data appliance 102 is configured to work in cooperation with a security platform (e.g., security platform 122). As one example, security platform 122 can provide to data appliance 102 a set of signatures of known-malicious files (e.g., as part of a subscription). If a signature for malware 130 (e.g., an MD5 hash of malware 130) is included in the set of signatures, data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known benign domains (e.g., site 152) and/or known malicious domains and/or IP addresses (e.g., site 156 and C&C server 150), allowing data appliance 102 to block traffic between enterprise network 140 and those malicious sites. The list of malicious domains (and/or IP addresses) can also help data appliance 102 determine when one of its nodes has been compromised. For example, if client device 104 attempts to contact C&C server 150, such attempt is a strong indicator that client 104 has been compromised by malware (and remedial actions should be taken accordingly, such as quarantining client device 104 from communicating with other nodes within enterprise network 140). Security platform 122 can also provide other types of information to data appliance 102 (e.g., as part of a subscription) such as a set of machine learning models usable by data appliance 102 to perform inline analysis of files.

A variety of actions can be taken by data appliance 102 if no signature for an attachment is found, in various embodiments. As a first example, data appliance 102 can fail-safe, by blocking transmission of any attachments not whitelisted as benign (e.g., not matching signatures of known good files). A potential drawback of this approach is that there may be many legitimate attachments unnecessarily blocked as potential malware when they are in fact benign. As a second example, data appliance 102 can fail-danger, by allowing transmission of any attachments not blacklisted as malicious (e.g., not matching signatures of known bad files). A potential drawback of this approach is that newly created malware (previously unseen by security platform 122) will not be prevented from causing harm. As a third example, data appliance 102 can be configured to provide the file (e.g., malware 130) to security platform 122 for static/dynamic analysis, to determine whether it is malicious and/or to otherwise classify it. A variety of actions can be taken by data appliance 102 while analysis by security platform 122 of the attachment (for which a signature is not already present) is performed. As a first example, data appliance 102 can prevent the email (and attachment) from being delivered to Alice until a response is received from security platform 122. Assuming security platform 122 takes approximately 15 minutes to thoroughly analyze a sample, this means that the incoming message to Alice will be delayed by 15 minutes. Since, in this example, the attachment is malicious, such a delay will not impact Alice negatively. In an alternate example, suppose someone has sent Alice a time sensitive message with a benign attachment for which a signature is also not present. Delaying delivery of the message to Alice by 15 minutes will likely be viewed (e.g., by Alice) as unacceptable. An alternate approach is to perform at least some real-time analysis on the attachment on data appliance 102 (e.g., while awaiting a verdict from security platform 122). If data appliance 102 can independently determine whether the attachment is malicious or benign, it can take an initial action (e.g., block or allow delivery to Alice), and can adjust/take additional actions once a verdict is received from security platform 122, as applicable.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136, and 148) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs open source and/or commercially available virtualization software, such as Linux Kernel based Virtual Machine (KVM), VMware ESXi, Citrix XenServer, and/or Microsoft Hyper-V. In some embodiments, the virtual machine server is omitted. Further, a virtual machine server may be under the control of the same entity that administers security platform 122, but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available the results of its analysis of samples via a list of signatures (and/or other identifiers) to data appliance 102 as part of a subscription. For example, security platform 122 can periodically send a content package that identifies malware apps (e.g., daily, hourly, or some other interval, and/or based on an event configured by one or more policies). An example content package includes a listing of identified malware apps, with information such as a package name, a hash value for uniquely identifying the app, and a malware name (and/or malware family name) for each identified malware app. The subscription can cover the analysis of just those files intercepted by data appliance 102 and sent to security platform 122 by data appliance 102, and can also cover signatures of all malware known to security platform 122 (or subsets thereof, such as just mobile malware but not other forms of malware (e.g., PDF malware)). Security platform 122 can also make available other types of information, such as machine learning models that can help data appliance 102 detect malware (e.g., through techniques other than hash-based signature matching).

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install endpoint protection software 134 on client device 110 that communicates with security platform 122 (e.g., to receive content packages from security platform 122, use the received content packages to check attachments in accordance with techniques described herein, and transmit applications to security platform 122 for analysis).

In various embodiments, security platform 122 is configured to collaborate with one or more third party services. As one example, security platform 122 can provide malware scanning results (and other information, as applicable) to a third-party scanner service (e.g., VirusTotal). Security platform 122 can similarly incorporate information obtained from a third-party scanner service (e.g., maliciousness verdicts from entities other than security platform 122) into its own information (e.g., information stored in database 146 or another appropriate repository of information).

In various embodiments, security platform 122 includes a DNS module 162. DNS module 162 can be implemented in a variety of ways. As shown in FIG. 2C, DNS module 162 makes use of commercially available public cloud resources, such as Amazon Web Services and/or Google Cloud Platform resources. Other platform resources provided by other vendors can also be used, as applicable (e.g., as offered by Microsoft), as can (in various embodiments) commodity server-class hardware.

DNS module 162 receives DNS query information (e.g., passive DNS data) from a variety of sources (254-258), using a variety of techniques. Sources 254-258 collectively provide DNS module 162 with approximately five billion unique records each day. An example of a record is:
abc.com A 199.181.132.250 2023 Jan. 1 12:30:49

The record indicates that, on Jan. 1, 2023, a DNS query was made for the site “abc.com” and at that time, the response provided was the IP address “199.181.132.250” (an “Address record” or “A record”). As used throughout the Specification, references to an “A record” can include both IPv4 (A) address records and IPV6 (AAAA) address records, based, for example, on implementation. In some cases, additional information can also be included. For example, an IP address associated with the requestor may be included in the passive DNS, or may be omitted (e.g., due to privacy reasons). Another example of a record is:
xyz.abc.com NS ns.abc.com 199.123.12.12 2023 Jan. 2 00:30:30

The record indicates that, on Jan. 2, 2023, a DNS query was made for the site “xyz.abc.com” and at that time, the response provided (also referred to as a “referral response” or “Nameserver (NS) record”) was to query the nameserver at ns.abc.com for more information about “xyz.abc.com.”

Source 254 is a real-time feed of globally collected passive DNS. An example of such a source is Farsight Security Passive DNS. In particular, records from source 254 are provided to DNS module 162 via an nmsgtool client, which is a utility wrapper for the libnmsg API that allows messages to be read/written across a network. Every 30 minutes, a batch process 262 (e.g., implemented using python) loads records newly received from source 254 into an Apache Hadoop cluster (HDFS) 260.

Source 256 is a daily feed of passive DNS associated with malware. An example of such a source is the Georgia Tech Information Security Center's Malware Passive DNS Data Daily Feed. Records from source 256 are provided to DNS module 162 as a single file via scp and then copied into HDFS 260 (e.g., using copyFromLocal on the file location 266 (e.g., a particular node in a cluster configured to receive data from source 256)).

As previously mentioned, appliance 102 can collect DNS queries made by clients 104-108 and provide passive DNS data to security platform 122. In some embodiments, appliances such as appliance 102 directly provide the passive DNS information to security platform 122. In other embodiments, appliance 102 (along with many other appliances) provides the passive DNS information to an intermediary, which in turn provides the information to security platform 122. In the example shown in FIG. 2C, data appliance 102, along with other appliances, such as appliances 136 and 148 (and thousands of other appliances, not pictured), provide their collected DNS information to a server, which in turn provides the collected information (as source 258) to security platform 122. In particular, source 258 provides the collected DNS information to a queue service 264 which in turn uses a set of workers 272 to copy records into HDFS 260. Other technologies can also be used to copy records into HDFS 260, such as Apache Kafka. In various embodiments, the DNS information provided to security platform 122 arrives filtered (e.g., by data appliances such as data appliance 102, by server/source 258, or both). One example of such filtering includes applying a filter specified by an administrator of appliance 102 (e.g., to prevent local DNS query information from leaving network 140).

A domain's activity degree can be quantified by the volume of DNS traffic it receives in a specific time window. When a domain starts hosting a legitimate launched service, its traffic usually grows gradually. It is abnormal for a domain to stay in the dormant status for a long time and then suddenly get a large burst of traffic (e.g., on its awaken date).

In some embodiments, security platform 122 (e.g., using pDNS analyzer 268) uses two thresholds to divide the activity index range into three groups: dormant domains (those below the 75th percentile of the activity index), standard domains (those with traffic in the 75th and 95th percentile), and highly active domains (the top 5%). Other groupings and/or other thresholds can also be used. Security platform 122 can continuously monitor the traffic of dormant domains and identify when activity jumps significantly in a short time window. Such domains exhibiting this behavior can be flagged by security platform 122 as strategically aged domains. The index data can be stored in a variety of ways. As an example, it can be stored in filesystem 260. It can also be stored in database 146. Other metrics can also be determined and stored, such as an awaken date for the domain (which can be set to null for dormant domains that have not yet shown burst activity).

### IV. Analyzing Samples Using Static/Dynamic Analysis

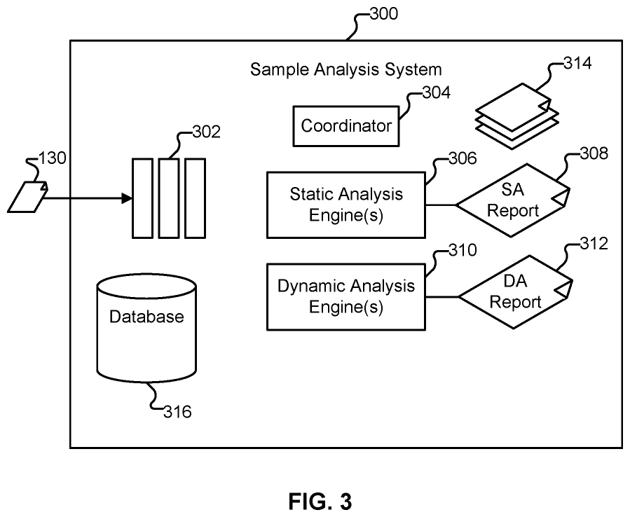

FIG. 3 illustrates an example of logical components that can be included in a system for analyzing samples. Analysis system 300 can be implemented using a single device. For example, the functionality of analysis system 300 can be implemented in a malware analysis module 112 incorporated into data appliance 102. Analysis system 300 can also be implemented, collectively, across multiple distinct devices. For example, the functionality of analysis system 300 can be provided by security platform 122.

In various embodiments, analysis system 300 makes use of lists, databases, or other collections of known safe content and/or known bad content (collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C&C) domains; signatures, hashes, and/or other identifiers of known malicious applications; signatures, hashes, and/or other identifiers of known safe applications; signatures, hashes, and/or other identifiers of known malicious files (e.g., Android exploit files); signatures, hashes, and/or other identifiers of known safe libraries; and signatures, hashes, and/or other identifiers of known malicious libraries.

### A. Ingestion

In various embodiments, when a new sample is received for analysis (e.g., an existing signature associated with the sample is not present in analysis system 300), it is added to queue 302. As shown in FIG. 3, malicious file 130 is received by analysis system 300 and added to queue 302.

### B. Static Analysis

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine (implementable via a set of scripts authored in an appropriate scripting language) obtains general information about the sample, and includes it (along with heuristic and other information, as applicable) in a static analysis report 308. The report can be created by the static analysis engine, or by coordinator 304 (or by another appropriate component) which can be configured to receive the information from static analysis engine 306. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

### C. Dynamic Analysis

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance. In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. During the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is suspicious or malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

### V. Detecting Fraudulent E-Commerce Websites

### A. Introduction

Phishing is a well-known type of scam where miscreants masquerade as trustworthy entities. The objective of phishing is to deceive people into releasing sensitive information such as Social Security Number or account credentials. Phishing attacks usually involve deceptive websites and are initiated by lures that trick victims into visiting the phishing websites, and these lures typically use email or private messages.

An emerging type of threat is generally referred to herein as a fraudulent e-commerce website (FCW) scam. FCWs have a different objective and monetization approach compared to phishing. Rather than impersonating known e-Commerce entities/brands as in phishing, FCWs attackers create fraudulent websites that appear to be legitimate e-Commerce websites. The goal of FCWs is to trick victims into paying for bogus goods or services that never arrive. One example of an FCW is a realistic looking online shopping website that tricks users into purchasing goods that never arrive. A second example of an FCW is a pet scam, in which victims purchase or adopt pets from a website which similarly never arrive. A third example of an FCW is a fake charity website (e.g., allegedly fundraising for victims of national or international tragedies, but not passing the collected funds on). FCWs do not necessarily impersonate well-known brands, but instead mimic the behavior and user experience of legitimate e-Commerce websites.

Modern defenses against phishing attacks are well-studied and ubiquitous in the web ecosystem. Because phishing websites impersonate well-known brands, they can often be detected using features such as URL or visual similarity to legitimate websites. Content take-downs, certificate intelligence, URL and content blocklisting, and classification are several examples of anti-phishing systems that can protect users from traditional forms of phishing. In addition, browser-based phishing detection systems such as Google Safe Browsing and Microsoft Windows Defender offer protections against traditional forms of phishing.

Unfortunately, existing phishing defenses are not effective for detecting FCWs. Detecting FCWs at the ecosystem level is problematic for a variety of reasons. FCWs, unlike traditional phishing websites, create a façade with similar behavior to legitimate websites. To do so, they have characteristics such as a well-defined website theme, social media logos, a proper contacts page, and valid payment gateways. Therefore, most FCWs cannot be easily detected by their appearance or URL related features alone. Impersonating a legitimate website's behavior and user experience, instead of replicating the exact look, is a main difference between phishing and FCWs. The monetization goal of FCWs is to trick the user into purchasing a product or service that never arrives (or is not donated to a legitimate charity), whereas the monetization goal of phishing is to steal credentials (that can later be monetized).

Another problem in detecting FCWs is that an up-to-date, publicly available dataset for detecting FCWs does not exist, which raises obstacles for using machine-learning approaches for detection. An up-to-date, clean dataset of FCWs needs to be collected in order to correctly reflect the status quo. However, curating a list of FCWs is a challenging task, in part, because they tend to disappear quickly. In addition, FCWs are not limited to one source of distribution such as email, and thus, can be difficult to collect. Further, because the content of FCWs plays an important role in detecting them, using naïve methods such as blind web crawling can result in an unsuitable dataset to study FCWs. As yet another example, the resulting crawled website data may include data from webpages that are not actually FCWs. Manually verifying each FCW is a time-consuming task that requires expertise. Another challenge is that FCWs evolve over time. For example, in the past, fake online shopping websites used exceedingly low prices to attract customers. Increasingly, however, fraudulent shopping websites quote reasonable prices (e.g., as users become aware that deals that are “too good to be true” are scams).

FIG. 1 illustrates an example of an environment in which FCWs can be detected (e.g., via phishing module 164). The threat posed by such FCWs can be reduced in a variety of beneficial ways. As one example, a list of such storefronts can be provided to firewalls, intrusion detection systems, intrusion prevention systems, or other appropriate appliances. Such a list can also be incorporated into software, such as endpoint protection (132, 134) or browser applications. Further, payment processors and/or domain registrars can be alerted to FCWs (e.g., to block payments and/or traffic).

### B. Known FCW Examples

The following are example types of known FCWs:

Fake Online Shopping: These websites mimic legitimate shopping websites to lure users, for example, by appearing to sell rare, desirable, or discounted items. Unique items make fake online shopping websites more visible to users when they try to search for the items, and discounted items attract more visitors. Miscreants use different techniques such as limited time offers or showing recent purchases as notifications to pressure users into buying the items.

Pet Scams: Pet scams claim to sell pets below market price. Miscreants aim to make victims emotionally attached to a fictitious pet. These websites appear legitimate at first glance because most of them do not have an in-site payment option. Rather, the miscreants ask users to fill out an application to be reviewed for eligibility (and collect payment information at that point, or after “approving” the application).

Fake Charity Websites: These scam websites use real world scenarios to take advantage of users' empathy. Fake charity or donation websites deceive users into thinking that they are helping people in need while in reality a miscreant receives the money. Typically, miscreants exploit recent crises. For example, attackers often use natural disasters, such as recent earthquakes and floods, to create fake charity websites pretending to help victims.

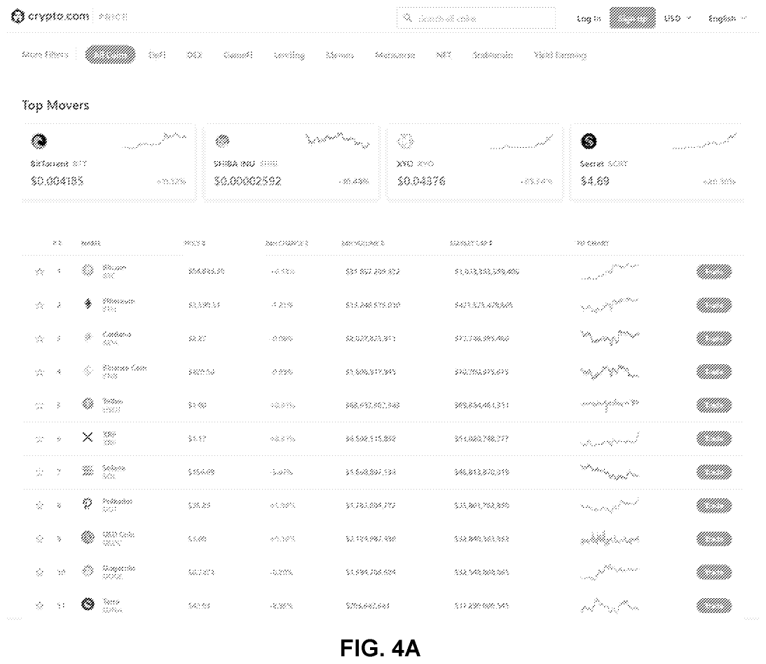

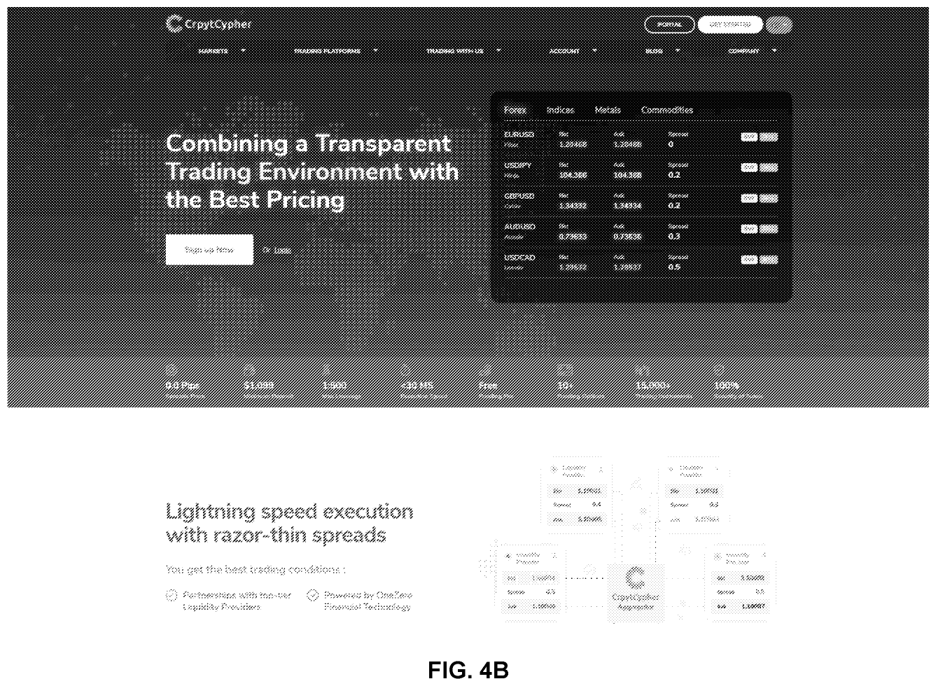

Fake Cryptocurrency or Stock Market Scams: Some people consider cryptocurrency and/or the stock market as a desirable investment opportunity. This creates an opportunity for miscreants to lure users into investing in their fraudulent cryptocurrency or high yield stocks. There are also several fake cryptocurrency exchanges. FIG. 4A shows an example of a legitimate cryptocurrency website and FIG. 4B shows an example of a fake cryptocurrency website. The fake cryptocurrency website has a similar user experience to the legitimate one, using a convenient website template, payment method, and having social media icons.

### C. Data Collection, Validation, and Analysis

### 1. Introduction

A typical approach to acquiring ground truths of malicious domains is to extract such domains from various blocklists (e.g., provided by Spamhaus, PhishTank, or OpenPhish) or from more general sources of malicious domains such as VirusTotal. Unfortunately, these sources have a number of issues. Existing collections of domains often have high false positive and false negative rates. Moreover, data collected for one approach (e.g., spam or phishing) generally does not transfer to another approach in a different domain. Accordingly, new techniques are needed to collect a comprehensive dataset of FCWs and use the dataset to train and deploy a quality model for detecting FCWs.

### 2. Data Collection

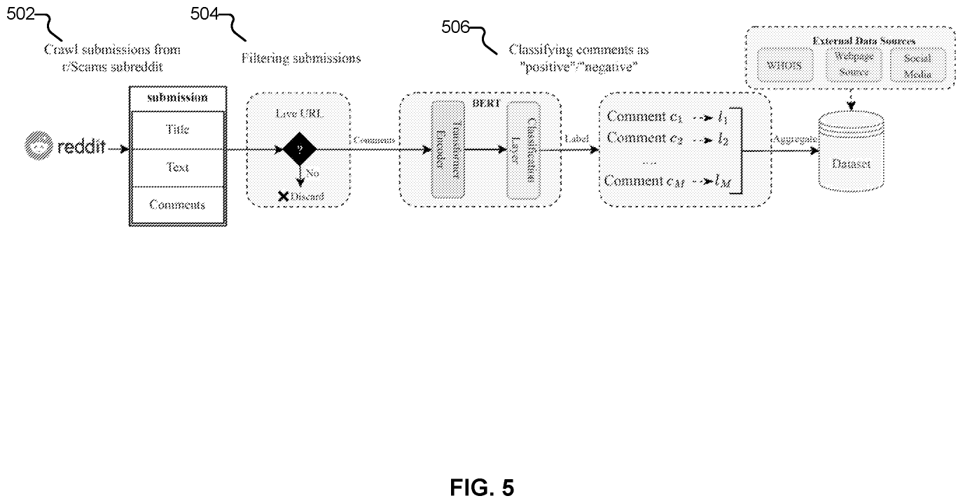

As mentioned above, a major challenge in analyzing FCWs is that there are no up-to-date or publicly available datasets. One approach is to construct such a dataset using FCWs in the wild. In an example embodiment, the social media platform Reddit (where a significant number of ˜330 million users discuss various topics in dedicated subreddits) is leveraged. Reddit is a structured and monitored (by moderators) social media platform where discussions are categorized into different areas of interest called a subreddit. In each subreddit, users discuss different subjects on a specific topic through a posting called a submission. One example subreddit is dedicated to users discussing FCWs (/r/Scams), from which a dataset of users' submissions and comments can be constructed. An approach to building such a dataset is as follows, and illustrated in FIG. 5. In various embodiments, the workflow illustrated in FIG. 5 is implemented on security platform 122 by phishing module 164 (e.g., using an appropriate scripting library and applicable libraries).

In the/r/Scams subreddit, users discuss if suspicious websites, emails, or calls are fraudulent or legitimate, and also share their experiences. In an example scenario, submissions to the subreddit are collected over a period of time by a crawler (502), some of which contain live URLs (504). For each collected URL, the full HTML source of the webpage is saved, along with its domain registration information (e.g., obtained through WHOIS). In addition, past posts are crawled. An example dataset of ˜33 k analyzed submissions has ˜9 k acquired live URLs with full HTML source of the webpage, and its domain registration information through WHOIS. An approach to measuring the current ecosystem-level protection against FCWs is to study the effectiveness of widely used mitigation systems such as Google Safe Browsing.

### 3. Data Labeling

Of the ˜9 k suspicious live URLs, FCWs need to be labeled. An approach to doing this is to automate labeling by analyzing the users' comments on each URL submitted to the subreddit. Users' comments can be used to understand the legitimacy of a suspicious URL. For example, if the shared URL is an FCW, users may comment “don't buy” or “common scam, move on.” Because each submission and its comments are rigorously monitored by the moderators of the/r/Scams subreddit, the comments can be considered credible. Moderators remove deceptive posts and comments to protect users. All of the submissions have at least one comment, with an average of nine and a median of four comments per submission (in an example scenario).

An approach to automating the labeling process based on users' comments is to train and use a Natural Language Processing (NLP) model that classifies each comment as positive or negative indicating whether or not each comment is a positive sentiment. An approach to creating an NLP model capable of classifying users' comments is to use a neural network classifier on top of the Bidirectional Encoder Representations from Transformers (BERT) model (506). BERT is a language model that can be used to perform various NLP tasks such as text generation, sentiment analysis, and question answering. To use BERT for sentiment analysis, first each comment is converted to a context vector g, containing important information about the comment. Then, the neural network classifier is used to label the context vector g as positive or negative. To train the model, the Stanford Sentiment Treebank binary classification dataset that contains 215,154 phrases along with {positive, negative} labels can be used. This dataset is used to train a general sentiment classification model that can be used to accurately predict the sentiment of the comments.

To classify and assign a label to every URL, each comment on a submission is classified. Then, a submission's URL is labeled as fraudulent if the number of negative comments is higher than positive comments. Additional information on an embodiment of the labeling process is provided below. In an example: considering ci as the context of i^{th} comment and y E {positive, negative} as its predicted label, the following equation can be used to determine the URL's label in submission y:

$$y = \{ \begin{matrix}frau d u l e n t & {\sum }_{i}^{{m}^{+}} I ( {\hat{y}}_{i}^{c} = n ) > {\sum }_{i}^{{m}^{-}} I ( {\hat{y}}_{i}^{c} = p ) \\ l e g i t i m a t e & o t h e r w i s e\end{matrix}$$

where I (.) is the indicator function, and m⁺ and m⁻ show the number of positive and negative comments of the submission, respectively.

### 4. Categorizing Fraudulent e-Commerce Websites

After collecting a dataset, the labeled FCWs can be categorized to understand the different types of FCWs. The source code of the collected data can be analyzed to assign each website to a category using a set of keywords. Of the FCW categories previously discussed, fake online shopping scams are the most common at 60.38% in an example dataset, while pet scams are second most popular at 20.52% of the dataset, fake charity websites are third most popular at 6.04% of the dataset, and cryptocurrency and stock market scams are fourth most popular at 3.91% in the dataset. Additional types of FCWs are also found:

Delivery Websites. Fraudulent delivery websites act as a support website for fraudsters who want to sell items to users. They can be used in the pet scam and fraudulent online shopping websites to show fake tracking history for non-existent packages. The delivery websites can prolong the longevity of other FCWs, making their users believe that the problem is within the shipping company and not the FCW.

Education Related Websites. These fraudulent websites sell services that target students who need help in writing essays, research papers, and other types of homework assignments. For some of these websites, rather than only taking the victim's money and not delivering the service, the miscreants additionally extort the students in exchange for not reporting them to their school.

Adult Content and Dating. This category includes websites related to adult content (providing fake adult content) and fake dating websites.

Other. Other types of fraudulent websites such as job offer scams and credit services are included in this category.

The following are examples of terms that can be used to identify FCWs in various categories:
Online Shopping: cart, shop, shoe, bag, ps4, ps5, xbox, nintendo, game, sale, and discount.
Education Related Websites: course, education, essay, study, school, assignment, paper, and tutor.
Adult Content: porn, pornography, sex, nude, and xxx.
Pet Scam: cat, dog, pet, breed, kitten, puppy, and puppies.
Delivery Websites: shipment, tracking, cargo, and delivery.
Charity Websites: charity, donation, donate, hungry, and hunger.
Cryptocurrency and Stock Market: bitcoin, crypt, BTC, blockchain, stock, trade, and trading.
Business Related Websites: credit, own, home, business, and finance.

### 5. Characteristics of FCWs

Once a labeled dataset of FCWs is obtained, it can be examined to identify features that distinguish FCWs from legitimate e-Commerce websites. Historically, one common characteristic among fake shopping websites was cheap prices: the discount amount can be used as a feature that can distinguish between fraudulent and legitimate websites. However, most of the recent FCWs do not offer significantly large discounts. Having a typical price range for items blends fraudulent e-Commerce with legitimate websites. People rely on social media to discover unknown brands. A social media presence can increase a brand's authority. Both popular brands and also new ones (even non-shopping websites) use social media to increase visibility. Initially, a lack of social media logo presence was a common trend in FCWs. However, newer FCWs are more likely to include social media on their website, yet, the added social media logos do not link to the FCWs' social media account. They either add only logos of different social media websites (with no link), or they include both logos and an invalid link. The invalid link can be any link to a social media website that is not the actual business's profile.

Another characteristic of FCWs is associated with their top-level domain (TLD). Miscreants want to spend less money to acquire domains, and therefore tend to use less expensive TLDs. In the example dataset, 29.46% of FCWs use inexpensive TLDs such as .xyz, store, and .shop, in comparison to 3.76% of legitimate websites. Moreover, fraudulent websites use inexpensive registrars more often (e.g., Namecheap, GoDaddy, Porkbun, NameSilo, Danesco, and Hostinger). In an example dataset, 57.16% of FCWs use inexpensive registrars, whereas 27.76% of legitimate websites use them.

Shopify is an e-commerce platform that simplifies creating an online shopping website. Sellers can create a shopping website by uploading their products, payment information, and choosing a theme to make their online store. Within an example collected dataset (e.g., collected using techniques described above), 61.35% of Shopify stores are FCWs. The high rate of Shopify FCWs reveals the fact that miscreants take advantage of such platforms to create their fake shops.

### D. Fraudulent E-Commerce Website Classification

This section describes an example detection method based on identified common characteristics of FCWs. A model can be created, also referred to herein as “Beyond Phish,” that can be used to detect FCWs from in-the-wild websites. Various features are defined based on analysis of the collected dataset. A model for detecting FCWs can be created by leveraging features from the website's content, DNS records, the website's URL, and its social media, as applicable in various embodiments.

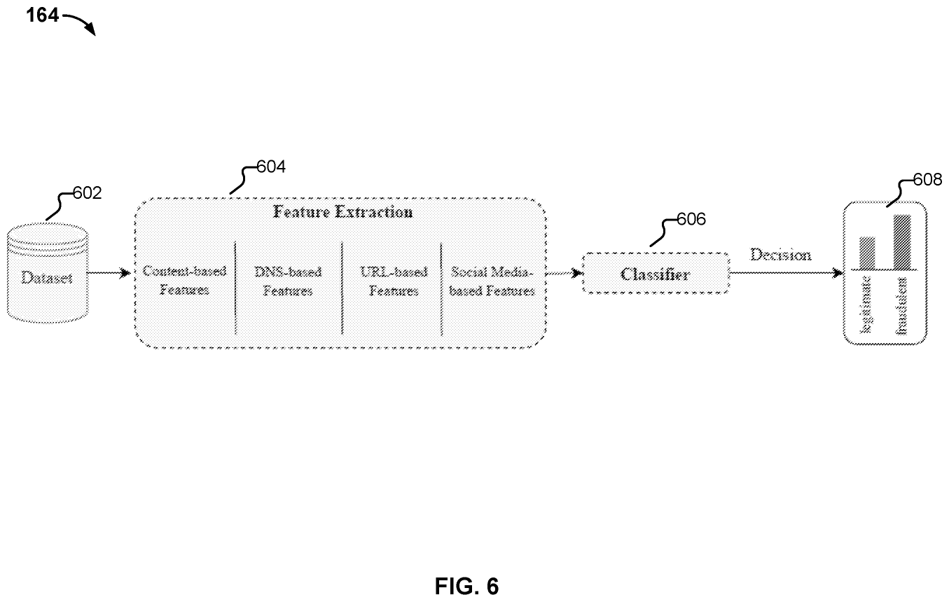

FIG. 6 illustrates an overview of a system for classifying FCWs. FIG. 6 illustrates an embodiment of phishing module 164. Dataset 602 is passed through a feature extraction module 604 which makes use of content-based features (e.g., extracted by a single page classifier), DNS records, URL-based features, and social media information. As applicable, preprocessing can be performed in connection with feature extraction. The output is a feature vector, for each URL, that can be used to produce a classifier 606 capable of separating FCWs from legitimate websites. In some embodiments, after the training process, the/r/Scams subreddit is monitored to extract new posts containing URLs and to evaluate performance of the trained classifier.

### 1. Feature Selection and Extraction

Each type of website (fraudulent or legitimate) has different characteristics that help the classifier to distinguish between them. Features can be categorized into four main groups: content-based, DNS-based, URL-based, and social media-based. Examples of features and feature types are given below in pairs of feature name and feature type.

Content-based Features: refer to the features which are based on the HTML source code of the website. Example features include:
Valid social media links (categorical). Legitimate websites commonly use social media for marketing purposes, and miscreants mimic legitimate websites by including a logo or links to social media sites such as Twitter, Instagram, or Facebook. However, these links are mostly invalid. Invalid links refers to social media URLs that point to another business, login page, or any other part of the social media website which is not an actual profile. For each social media site, a separate feature is considered and the feature's value is set to-1 if the website does not contain any link to the social media, set to 0 if there is an invalid social media link, and set to 1 if there is a valid social media link.
Number of external links (quantitative). FCWs often create closed environments (no outgoing links), while legitimate sites have large numbers of outgoing links. On average, legitimate websites have ˜2 times more outgoing links than FCWs. This feature is a discrete value that is greater than 0.
Number of script tags (quantitative). The number of script tags is extracted from the HTML source of the website, including both external (with an src attribute) and inline. A high number of script tags can indicate malicious activity. In an example dataset, FCWs contain an average of 23 script tags while legitimate ones contain 13 script tags on average.

DNS-based Features: are based on public WHOIS information regarding the most recent URL's domain registration:
Domain Age (quantitative). Miscreants abandon their domains after blocklisting or being reported. Thus, it is common for FCWs to have a recent registration date. The number of days between the current date and the website's creation date can be assigned to this feature. In an example dataset, FCWs have a short average age of 2 years, while legitimate ones have an average age of 13 years.
Registration period (ordinal). The “Expiration Date” in WHOIS information indicates when the domain is going to expire. A domain can be registered for one to ten years. Because longer registrations cost more, miscreants tend to register domains for short periods. The value of this feature is the number of years between the expiration and the creation date. In an example dataset, most FCWs are only registered for 1 year.
Domain registration country (categorical). In an example dataset, 56% of FCWs use a country other than US, CA, or UK as their registered country. Among those FCWs, Panama (“PA”) is the most commonly used country (accounting for 43%). This trend has not changed since December 2018. To include this information in the feature vector, a one-hot vector indicating the registrar country based on the domain's WHOIS record is used.
Host country (categorical). Similar to the domain registrar country, the country is one-hot encoded, based on the website's IP address.
Same host and domain country (ordinal). A website's host country does not need to be the same as the registrar country. This feature indicates whether the host and domain country of a website are the same or not. In an example dataset, legitimate websites have 3 times greater odds of having the same host and domain country than FCWs.
Cheap registrar (categorical). Miscreants generally register their domains through registrars with the cheapest price. Namecheap, GoDaddy, Porkbun, NameSilo, Danesco, and Hostinger are among the top registrars that offer domains at low prices. If the website's registrar is one of the aforementioned registrars, this feature will be set to 1, otherwise 0.
Domain privacy (ordinal). In an example dataset, a third of FCWs use private WHOIS to hide their identity in our dataset. This binary feature indicates whether a website is using private WHOIS.
Alexa top 100K (ordinal). FCWs are expected to draw less traffic than legitimate ones. This binary feature indicates if the website's Alexa rank is less than one hundred thousand.

URL-based Features: consider parts of the URL:
Cheap TLD (ordinal). In an example dataset, 28% of FCWs use cheap TLDs, such as .xyz and .store. According to the average price of domain registrations, the 50 cheapest TLDs (average price under $2) are considered when constructing a binary feature indicating if the URL uses a cheap TLD name or not.
Hyphen in domain (ordinal). One way to obfuscate well-known domain names is to add a hyphen (“-”) in the name. This binary feature shows if the domain name includes a hyphen.
Digit in domain (ordinal). Another way of domain name obfuscation is to use digits in the domain name. This binary feature shows if the domain name includes digits.
Sub-domain level (quantitative). Legitimate websites have ˜9 sub-domains on average while FCWs have ˜20. Some FCWs attempt to confuse users by placing brand names in subdomains (such as nike.shoes.example.com).

Social Media-based Features: provide information about the social media profiles related to a website:
Number of followers (categorical). Another feature that provides insight regarding the credibility of social media is the number of followers (f). The number of followers can have a wide range depending on different factors such as the popularity of a brand, so the feature is bucketed into five categories as follows:

$$\begin{matrix}1 : 1 \geq f < 50 \; 00 , \\ 2 : 5000 \geq f < 150 \; 00 , \\ 3 : 15000 \geq f < 500 \; 00 , \\ 4 : 50000 \geq f < 10 \; 0000 , and \\ 5 : 100000 \geq f .\end{matrix}$$

Age of social media account (quantitative). As more and more fraudulent websites try to mimic legitimate websites and include social media links in their websites, it is important to check the credibility of the corresponding social media accounts. Age of social media account is one of the indicators of credibility of a business and can be determined, for example, by crawling creation date of Facebook and Twitter accounts.
Number of likes (quantitative). This feature is applicable to websites with Facebook links, which shows how many users have liked the website's Facebook page. To quantize this feature, the same approach can be used as the number of followers.

### 2. Model Architecture

An FCW detection model (e.g., Beyond Phish) can be created based on the above described defined features. The input to the classifier (e.g., 606) is a feature vector x containing attributes described above (e.g., constructed via 604), and the output is the probability p (608) of a website being legitimate or fraudulent. A variety of classifiers can be used to detect FCWs including random forest, XGBoost, SVM, and a feed-forward neural network. Additional detail on modeling approaches is provided below.

In an example embodiment, legitimate e-Commerce websites (e.g., verified by security experts) are added to the dataset for training and testing purposes, including both older domains and more newly registered ones. In an example embodiment, legitimate commerce websites and collected URLs from Reddit amount to 12 k legitimate and 6 k fraudulent URLs and corresponding features.

Neural networks act as black boxes when it comes to interpretability. Various methods have been proposed to help interpret the prediction of neural network models. SHapley Additive explanations (SHAP) is a unified framework for interpreting a model's predictions. For a specific prediction, SHAP assigns each feature an importance value, known as a “Shapley value.” Considering each feature as a variable, Shapley values measure the impact of each variable taking into account the interaction with other variables. SHAP computes these values based on a comparison of what a model predicts with the feature and without the feature.

DeepSHAP is a variant of the SHAP framework that uses back-propagation values in a neural network to find important features. DeepSHAP can be used to determine a score and rank of each feature in an FCW detection model considering the target label as legitimate and fraudulent, respectively. The scores are normalized absolute Shapely values.

### E. Details of Example Trained Models

Example parameter settings for Random Forest, SVM, and XGBoost approaches are below:

| Model | Parameter | Value |
|---|---|---|
| SVM | kernel | rbf |
| | gamma | scale |
| RF | max_depth | 10 |
| | min_samples_split | 2 |
| | n_estimators | 100 |
| XGBoost | objective | Binary: logistic |
| | eta | 1 |
| | n_estimators | 100 |
| | max_depth | 10 |

In an example embodiment, the designed neural network classifier comprises six layers. The input x is a feature vector that will be passed through the network to output the probability of the input being an FCW:

$$\begin{matrix}{o}_{1} = tanh ( {W}^{( 1 )} x + {b}^{( 1 )} ) \\ {o}_{2} = tanh ( {W}^{( 2 )} {o}_{1} + {b}^{( 2 )} ) \\ {o}_{3} = tanh ( {W}^{( 3 )} {o}_{2} + {b}^{( 3 )} ) \\ {o}_{4} = tanh ( {W}^{( 4 )} {o}_{3} + {b}^{( 4 )} ) \\ p = sigmoid ( {W}^{( 5 )} {o}_{4} + {b}^{( 4 )} )\end{matrix}$$

Where {o⁽ⁱ⁾}ᵢ₌₀⁴ is the output of each layer, and {W⁽ⁱ⁾, b⁽ⁱ⁾}ᵢ₌₀⁴ are learnable network parameters.

For this task the following loss function L can be used to calculate the loss value for the classifier:

$$L = - \frac{1}{M} {\sum }_{i = 1}^{M} {w}_{i} ( {y}_{i} log ( {p}_{i} ) ) + ( 1 - {y}_{i} ) log ( 1 - {p}_{i} ) )$$

where M is the number of samples and wᵢ indicates the weight of each data. Example values to train the model are using w_{legitimate}=0.8 and w_{scam}=0.2 for legitimate and FCW samples, respectively. This weight assignment penalizes the model for misclassifying the legitimate samples more than misclassifying the FCW samples.

Given the formulation of the MLP classifier F, the aim is to find the optimal network parameters {W⁽ⁱ⁾, b⁽ⁱ⁾}ᵢ₌₀⁴. Adam optimizer can be used to minimize the loss function L and optimize the network parameters. Moreover, Batch Normalization (BN) can be used to accelerate the learning process and solve the vanishing gradient problem when using the sigmoid activation function. BN is applied to each data batch B={x₁, x₂, . . . , x_{b}} with size b during the training process. It transforms B to a new data batch B′={x′₁, x′₂, . . . , x′_{b}} as (x′=xᵢ−μ_{B})/\sqrt{σ_{B}²+ϵ}, where

$${μ}_{ℬ} = \frac{1}{m} {\sum }_{i = 1}^{b} {x}_{i}$$

indicates the batch mean,

$${σ}_{ℬ}^{2} = \frac{1}{m} {\sum }_{i = 1}^{b} {( {x}_{i} - {μ}_{ℬ} )}^{2}$$

is the batch variance, and e is a constant small number added to the batch variance for numerical stability.

In some embodiments, the machine learning framework PyTorch is used to implement the model. Each hidden layer of the MLP classifier has {2048, 1024, 512, 256} neurons, respectively. During training, a batch size of 32 is used, in an example embodiment, to sample data from the training set. The batch is passed through the classifier to output the probability, thus calculating the loss value using eq: loss. Then, the MLP classifier is updated using Adam optimizer with a learning rate of 0.0001.

An example way to test the trained classifier is to use the following formula to convert the classifier's output probability into a label:

$$\hat{y} = \{ \begin{matrix}fraudulent & p > 0.5 \\ legitimate & p \leq 0.5\end{matrix}$$

where y\hat{ } is the predicted label using the MLP classifier, and p is the output probability.

### F. Example Deployment Scenarios and Various Embodiments

Techniques described herein can be used to protect users from FCWs in a variety of ways. Current traditional blocklists cannot detect FCWs. The described approaches can be used as a complementary system alongside current blocklists such as GSB or Microsoft Windows Defender. This way, not only will users be protected against phishing and malware, but they can also be warned about possible FCWs.

Around 100,000 domains are registered daily, and some of these will be used for FCWs. Another deployment scenario is for domain registrars or website building platforms, such as Shopify, to use FCW detection described herein as a screening method to scan newly created websites and take action against possible FCWs. Content-based features are important in detecting FCWs. However, as many newly registered domains do not have content, it can be difficult to classify them at an early stage. One way to quickly determine domain reputation is to consider only URL and DNS-based features.

As mentioned above, in various embodiments, security platform 122 includes a phishing module 164. Phishing module 164 can make use of techniques described herein to identify traditional phishing pages, and can also be used to identify FCWs. Once identified, a variety of actions can be taken, such as publishing a list of detected FCWs (e.g., as a blocklist) to data appliances such as data appliance 102, to endpoint protection applications (e.g., endpoint protection 132 and 134), etc.

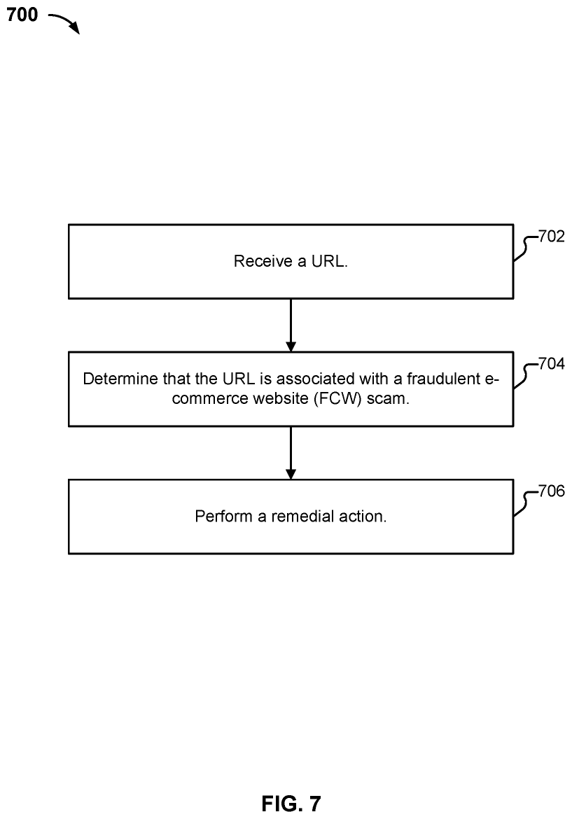

FIG. 7 illustrates an embodiment of a process for detecting FCW scams. In various embodiments, process 700 is performed by security platform 122. Process 700 can also be performed by other entities, such as embodiments of data appliance 102 (e.g., where an embodiment of phishing module 164 is collocated on data appliance 102).

Process 700 begins at 702 when a URL is received. As one example, a URL can be received at 702 by security platform 122 from data appliance 102 (e.g., where a verdict for the URL is not present in a cache on data appliance 102). As another example, a URL can be received at 702 by security platform 122 from a feed (e.g., provided by another component of security platform 122 such as a crawler/URL classifier pipeline, or provided by a third party service such as VirusTotal).

At 704, a determination is made that the received URL is associated with an FCW scam. In particular, a website reachable via the URL can be evaluated using one or more models trained for FCW evaluation in accordance with techniques described herein. As described herein, a variety of different types of features, used to train such models (e.g., neural network-based models), are extracted from/determined for the URL received at 702. One example type of feature is extracted from text on the website (e.g., presence of keywords “discount,” “shopping,” or “pet”). A second type of feature is extracted from the structure of the website (e.g., number of script tags). A third type of feature is extracted from DNS information (e.g., passive DNS counts and registration period). Additional types and examples of features are provided above.

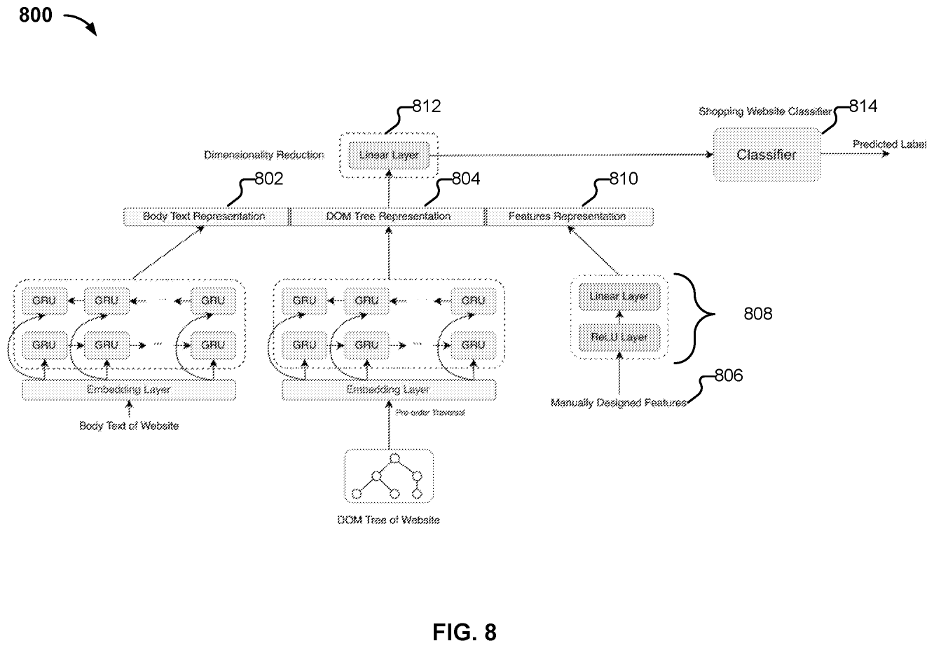

FIG. 8 illustrates an example of a model that can be used to detect FCW scams. In various embodiments, model 800 is used by phishing module 164. As shown in FIG. 8, body text of a website (e.g., accessed by a crawler in response to receipt of a URL at 702) is converted to tokens. As explained above, one approach is to use a BERT multilingual tokenizer to split text into tokens. Each token is converted to an embedding vector where each token gets a series of numbers that represent what that token means. In an example embodiment, the sequence of tokens is truncated or padded as necessary to reach a sequence length of 1024 tokens. Gated recurrent units (GRUs) are used to analyze the text in a bidirectional fashion and ultimately determine a body text representation of the website content (802).

Fraudulent e-commerce websites are often template created. There will often be similarities in the way the HTML of such websites are structured, even if differences exist in the items being “sold.” The Document Object Model (DOM) tree of the website is extracted (e.g., by a crawler). The DOM tree is traversed, resulting in a sequence of tags which are then converted to tokens. An analysis similar to that of the website text (e.g., conversion to an embedding vector and analysis using GRUs) can then be performed to generate a DOM tree representation of the website (804).

Examples of manually designated features 806 include URL-based features, domain/DNS-based features, and content-based features. Examples of URL-based features include the number of hyphens and number of digits present in the URL. An example of a domain-based feature is the age of the domain-how many years or months records for the domain have existed. An example of a DNS-based feature is the number of hits the domain has received in passive DNS records. Examples of content-based features include the number of JavaScript tags, number of external links, and whether the domain matches a social media link present on the page.

Additional examples of such features are provided above. Once extracted (e.g., by a crawler or other appropriate tool), linear layers 808 are applied to process the features, resulting in a third feature vector (810).

The three representation vectors: body text representation vector 802, DOM tree representation vector 804, and manual feature vector 810 are then concatenated/processed by linear layer 812. Finally, a voting layer (also referred to herein as a classifier) determines a verdict (e.g., 0 or 1) for the URL received at 702.

Returning to FIG. 7, if the received URL is determined to be an FCW (e.g., classifier 814 returns a score that exceeds a threshold), a remedial action is taken at 706. One example action that can be taken is that the URL can be added to a list/database of known phishing URLs (and/or more specifically, a list of FCW URLs, e.g., hosted by security platform 122). The list of known phishing URLs (including the URL received at 702) can be propagated to data appliances such as data appliances 102, 136, and 148, to ensure that any end users of networks 140, 114, and 116 will be protected (blocked) from accessing the identified URL.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive a URL;
determine that the URL is associated a with fraudulent e-commerce website (FCW) scam, at least in part by applying a previously trained model to content associated with the URL; and
perform a remedial action in response to the determination; and
a memory coupled to the processor and configured to provide the processor with instructions.

2. The system of claim 1, wherein determining that the URL is associated with the FCW scam includes tokenizing a structure associated with a website reachable via the URL.

3. The system of claim 2, wherein tokenizing the structure includes converting a Document Object Model (DOM) tree into a sequence of tokens.

4. The system of claim 1, wherein determining that the URL is associated with the FCW scam includes tokenizing content on a website reachable via the URL.

5. The system of claim 1, wherein determining that the URL is associated with the FCW scam includes evaluating a domain age associated with the URL.

6. The system of claim 1, wherein determining that the URL is associated with the FCW scam includes evaluating a registration period associated with the URL.

7. The system of claim 1, wherein determining that the URL is associated with the FCW scam includes evaluating a domain registration country associated with the URL.

8. The system of claim 1, wherein determining that the URL is associated with the FCW scam includes evaluating a host country associated with the URL.

9. The system of claim 1, wherein determining that the URL is associated with the FCW scam includes determining whether a domain registration country associated with the URL matches a host country associated with the URL.

10. The system of claim 1, wherein determining that the URL is associated with the FCW scam includes evaluating a registrar associated with the URL.

11. The system of claim 1, wherein determining that the URL is associated with the FCW scam includes evaluating a domain privacy associated with the URL.

12. The system of claim 1, wherein determining that the URL is associated with the FCW scam includes evaluating a domain popularity ranking associated with the URL.

13. The system of claim 1, wherein determining that the URL is associated with the FCW scam includes evaluating one or more features of the URL.

14. The system of claim 13, wherein at least one feature of the URL is a TLD of the URL.

15. The system of claim 13, wherein at least one feature of the URL is a presence of one or more hyphens in the URL.

16. The system of claim 13, wherein at least one feature of the URL is a presence of one or more digits in the URL.

17. The system of claim 13, wherein at least one feature of the URL is a subdomain level associated with the URL.

18. The system of claim 1, wherein determining that the URL is associated with the FCW scam includes evaluating one or more social media-based features associated with a website reachable via the URL.

19. The system of claim 18, wherein evaluating the one or more social media-based features includes evaluating whether there is a match between a domain of the website and a social media link.

20. The system of claim 18, wherein evaluating the one or more social media-based features includes determining a number of followers.

21. The system of claim 18, wherein evaluating the one or more social media-based features includes determining an age of an associated social media account.

22. The system of claim 18, wherein evaluating the one or more social media-based features includes determining a number of likes associated with a social media account.

23. The system of claim 1, wherein determining that the URL is associated with the FCW scam includes determining a number of external links in HTML.

24. The system of claim 1, wherein determining that the URL is associated with the FCW scam includes determining a number of script tags in HTML.

25. The system of claim 1, wherein the processor is further configured to generate embedding vectors based on tokens in body text within HTML.

26. The system of claim 1, wherein the processor is further configured to train the model using a first set of tokens extracted from a set of benign shopping sites and a second set of tokens extracted from a set of FCWs.

27. A method, comprising:
receiving a URL;
determining that the URL is associated a with fraudulent e-commerce website (FCW) scam, at least in part by applying a previously trained model to content associated with the URL; and
performing a remedial action in response to the determination.

28. A computer program product embodied in a non-transitory computer readable medium and comprising computer instructions for:
receiving a URL;
determining that the URL is associated a with fraudulent e-commerce website (FCW) scam, at least in part by applying a previously trained model to content associated with the URL; and
performing a remedial action in response to the determination.
